(19) United States
(12) Patent Application Publication
(10) Pub. No.: US 2015/0314249 A1
(43) Pub. Date: Nov. 5, 2015

(54) CARBONATION VIA A CARBON FILTER MEDIA

(71) Applicant: WHIRLPOOL CORPORATION, Benton Harbor, MI (US)

(72) Inventors: NIHAT O. CUR, St. Joseph, MI (US); STEVEN J. KUEHL, Stevensville, MI (US); MARK M. SENNINGER, St. Joseph, MI (US)

(73) Assignee: WHIRLPOOL CORPORATION, Benton Harbor, MI (US)

(21) Appl. No.: 14/265,690

(22) Filed: Apr. 30, 2014

(51) Int. Cl. B01F 3/04; A23L 2/54; B01F 15/06

(52) U.S. Cl. CPC B01F 3/04808; B01F 15/063; A23L 2/54; A23V 2002/00; B01F 2003/049; B01F 2015/061; B01F 2215/0022

(57) ABSTRACT

An appliance for dispensing a chilled, carbonated liquid includes a mixer connected to a water source and a carbon dioxide source. A highly activated carbon filter is placed downstream from the mixing chamber between the mixing chamber and a dispenser.

### BACKGROUND OF THE DISCLOSURE

The present disclosure relates to the art of dispensing carbonated beverages and, more particularly, to the operation of an in-line carbonated liquid dispenser.

### SUMMARY OF THE PRESENT DISCLOSURE

One aspect of the current disclosure includes a refrigeration appliance with a water dispenser. The water dispenser includes a mixer connected to the water source and a carbon dioxide source, and a highly activated carbon filter disposed between the mixer and the dispenser.

Another aspect of the present disclosure includes a carbonation system disposed in series within a chilled water dispensing system. The carbonated liquid dispenser includes a cooling system in thermal contact with the water upstream from the carbonator. The chilled water is mixed with carbon dioxide in a mixer which is fluidly connected to a highly activated carbon filter for continuous carbonated liquid dispensing.

Yet another aspect of the present disclosure includes a method of providing continuous carbonated water by providing a water source and a carbon dioxide source, mixing the water and carbon dioxide in a mixer, urging the water and carbon dioxide mixture through a highly activated carbon filter, and dispensing out of a dispenser with a user-controlled valve.

Yet another aspect of the present disclosure includes a carbonation system of the various aspects of the present disclosure discussed herein wherein the carbonation system produces carbonated water in a continuous manner. The system allows for the production of carbonated water in a non-batch production manner.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a isometric view of one example of a dispensing refrigerator.

FIG. 2 is a schematic illustration of one type of system to pump water.

FIG. 3 is a schematic of one type of in-line carbonation system.

FIG. 4 is a schematic of another in-line carbonation system.

### DETAILED DESCRIPTION OF EMBODIMENTS

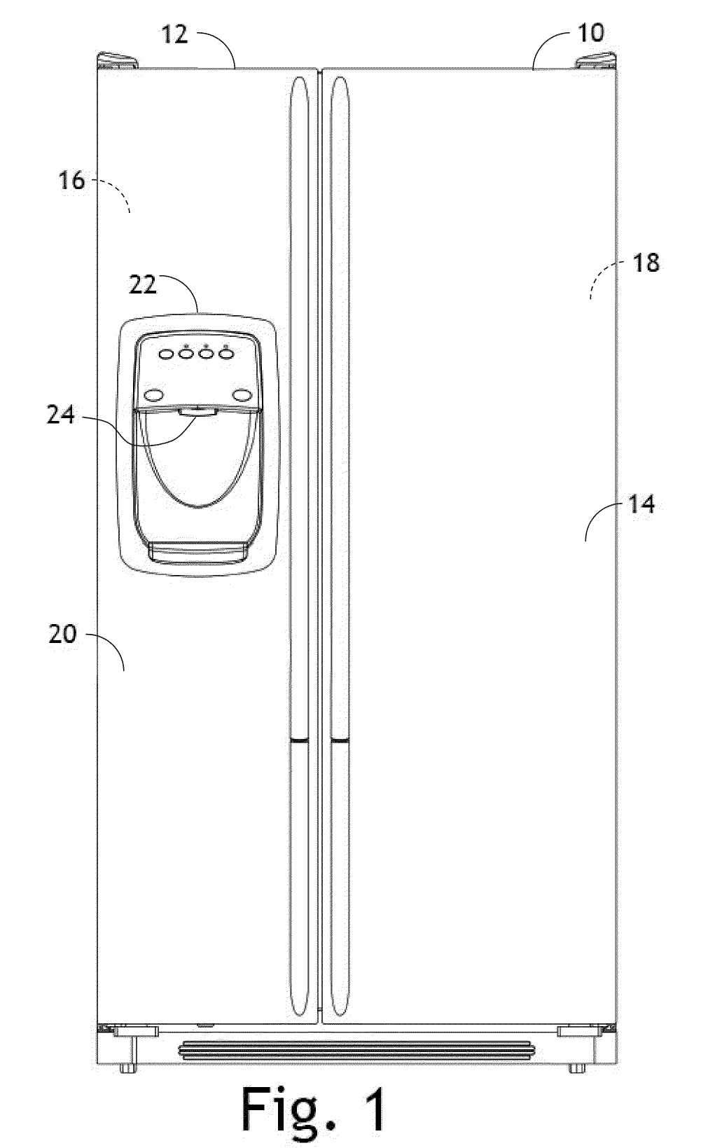

For purposes of description herein, the terms “upper,” “lower,” “right,” “left,” “rear,” “front,” “vertical,” “horizontal,” and derivatives thereof shall relate to the disclosure as oriented in FIG. 1. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Where a range of values is provided, it is understood that each intervening value, to the tenth of the unit of the lower limit unless the context clearly dictates otherwise, between the upper and lower limit of that range, and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure.

In this specification and the appended claims, the singular forms “a,” “an” and “the” include plural reference unless the context clearly dictates otherwise.

FIG. 1 is a perspective view showing an embodiment of a refrigerator 10 having a beverage dispensing system 22. The refrigerator 10 includes a refrigerator cabinet 12. The cabinet 12 is an insulated cabinet. The refrigerator 10 further includes a fresh food compartment 14 and a freezer compartment 16, which are disposed within the refrigerator cabinet 12. A fresh food door 18 provides access to the fresh food compartment 14. A freezer door 20 provides access to the freezer compartment 16. The beverage dispensing system 22 may include a dispenser 24. Although the refrigerator 10 of FIG. 1 is shown in a side-by-side configuration, the refrigerator may be otherwise configured, such as in a bottom mount configuration with French doors.

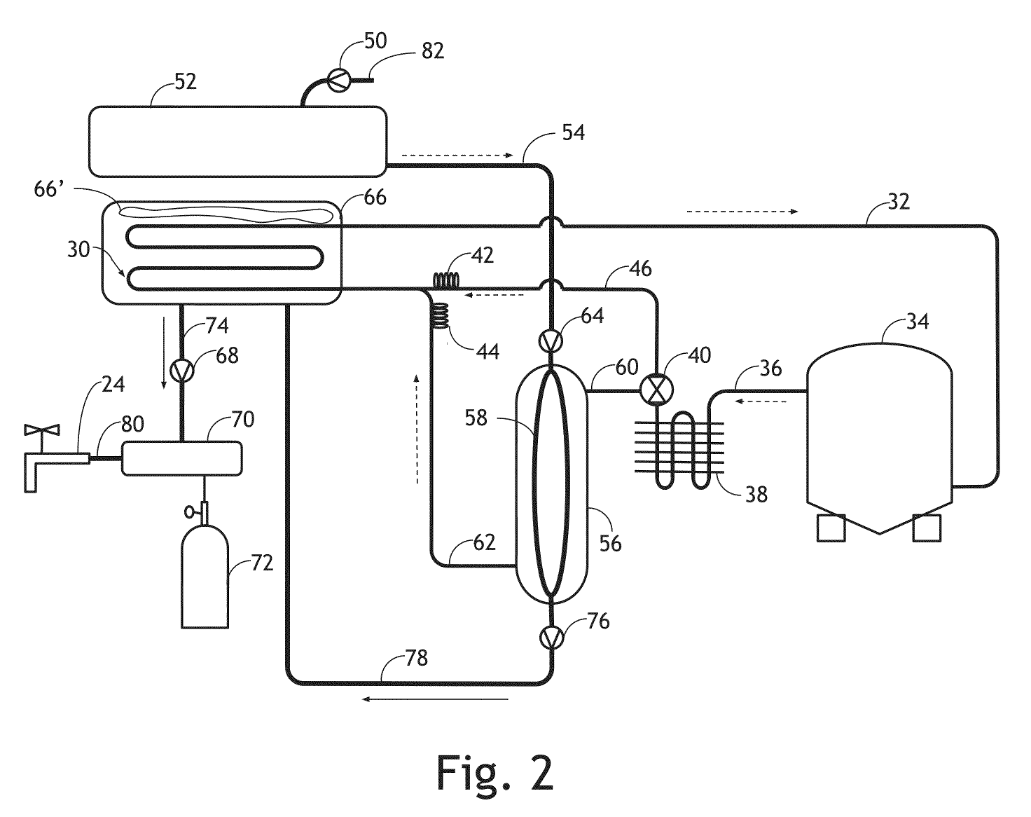

Details of a refrigeration system for the refrigerator 10 will be set forth with reference to FIG. 2. As shown, the refrigeration system may have a compressor 34. The compressor may be connected at an inlet (not shown) to a suction line 32. The compressor may also be connected at an outlet (not shown) to a discharge line 36. Downstream from the compressor outlet the discharge line 36 leads to a condenser 38. The condenser 38 leads to a refrigerant three-way valve 40. The main refrigerant liquid line 46 connects the refrigerant three-way valve 40 to an expansion device 42. The outlet (not shown) of the expansion device 42 connects to an evaporator 30. From the evaporator 30, the suction line 32 connects back to the inlet of compressor 34 as described above.

Also stemming from the refrigerant three-way valve 40, is a canister inlet line 60, which is connected to an inlet (not shown) on a canister 56. The canister 56 also has an outlet (not shown) that leads to a canister outlet line 62. The canister outlet line connects to an expansion device 44 which leads back into evaporator 30.

Potable water enters the refrigerator from a household portable water line (not shown), and a household portable water valve 50 allows potable water into an ambient water reservoir 52. The ambient water reservoir 52 is connected to a bladder 58 via a water line 54 and a two-way water valve 64. The bladder 58 may be a double-walled structure of a food-grade elastic material which may be substantially gas impermeable. Downstream from this is a bladder outlet valve 76 leading into a bladder outlet line 78. The bladder outlet line 78 is connected to a chilled water reservoir 66 which is in turn connected to a water reservoir outlet line 74 with the check valve 68. The water reservoir outlet line 74 is connected to a carbonator 70. A carbon dioxide source 72 is connected to the carbonator 70 which provides carbonation to the carbonator 70. The dispenser 24 is connected to the carbonator 70 through a dispenser line 80 at an outlet of the carbonator 70.

Ambient potable water is introduced into the insulated water reservoir 52. The water may be manually filled to an atmospheric pressure in the insulated water reservoir 52 and gravity fed to the bladder 58, or may be automatically introduced into the water reservoir 52 via a household potable water inlet (not shown) and a two-way valve 50.

When a user indicates that potable water is necessary at the dispenser 24, via a button on the user interface, a lever in the beverage dispensing system 22, or any other suitable input, a proximity switch (not shown) may provide a signal to the control (not shown). The control may send a signal to the refrigerant three-way valve 42 open up towards the canister inlet line 60, as well as signaling the compressor 34 to start. At the same time the bladder inlet valve 64 may close, and a bladder outlet valve 76 may open. Valves 64 and 76 may also be check valves, and prevent backflow thus only allowing flow in a direction from the potable water inlet to the outlet 24.

With the compressor 34 running, high pressure liquid issues from the condenser 38 and into the refrigerant three-way valve 40. The refrigerant three-way valve 40 may allow the high-pressure liquid to travel through the canister inlet line 60 and into the canister 56, increasing the pressure around the bladder 58. Optimally, the high-pressure liquid exiting the compressor 34 will be charged to a pressure of from about 120 to about 150 psig. This increased pressure on the bladder 58 will force the water through the now open bladder outlet valve 76 and through the bladder outlet line 78. The water will continue to travel into the pressurized water reservoir 66 where the water is chilled by the evaporator 30. The water may be chilled through direct contact with the evaporator 30 which may be located in the pressurized water reservoir 66. In another embodiment, the evaporator may be in thermal contact with the exterior of the pressurized water reservoir 66, cooling the reservoir and indirectly cooling the water within the pressurized water reservoir 66.

Air contained within a bladder 66′ disposed in the pressurized water reservoir 66 is compressed, and can act as a buffer when the pressurized water reservoir 66 is open to dispense so that the incompressible water is not dramatically reduced in pressure in the pressurized water reservoir 66 leading to the carbonator 70. Optimally, this compressed air will keep the water held in the pressurized water reservoir 66 at a pressure of from about 70 to about 130 psig.

From the pressurized water reservoir 66 the water will travel down the water reservoir outlet line 74 through a check valve 68 and into the carbonator 70. The carbonator 70 is connected to a carbonation source 72, which as shown is a carbon dioxide bottle with a regulator. The water travels through the carbonator 70 and is carbonated before traveling through the dispenser line 80 and exiting the refrigerator through the dispenser 24 where the user may access the now carbonated, chilled water. In another embodiment, the dispensing system 22 may also bypass the carbonator 70 and dispense non-carbonated water out of the dispenser 24.

Once the bladder 58 is collapsed, the refrigerant three-way valve 40 allows flow through the parallel circuit to the evaporator 30 used to chilled water in the pressurized water reservoir 66. The suction line 32 may be thermally coupled to the condenser 38 and ensuring any liquid refrigerant not flashed in the evaporator 30 is vaporized before returning to the compressor 34. Thus, a water pump capable of reaching refrigerant compressor condensing pressures (high enough to provide for good carbonation levels) is provided for the price of a three-way refrigerant valve and some connecting tubing and capillary tubing.

In another embodiment, the pressure on the bladder 58 may be supplied pneumatically by the carbon dioxide source 72. In this embodiment, a CO₂ gas line stems from the carbon dioxide source 72, to the canister 56, filling the canister 56 with CO₂ gas until a desired pressure on the bladder 58 is reached.

In operation, a user actuates a valve or a switch to dispense fluid on the user interface 22 or at the nozzle 24, sending a signal to a refrigerator control (not shown) that water is desired at the nozzle 24. In turn, a drop in pressure in pressurized water reservoir 66 is sensed and the compressor 34 is activated. Valve 40 may be closed to line 46 and opened to line 60, thus sending pressurized refrigerant into canister 56, thus collapsing the bladder 58 and forcing water out of the bladder 58, through line 78, and into pressurized water reservoir 66, thus restoring pressure in the reservoir 66. The refrigerator control may include some time delay mechanism to allow water to fill the bladder 58 prior to compressor discharge pressure reaching desired pressure levels. Initially, the valve 40 will be open to line 46, which allows the pressure within line 60, canister 56, and line 62 to drop, allowing water to fill the bladder 58. This sequence may be repeated based on a function of desired pressure within the reservoir 66. The desired pressure may be detected within the canister 56 and reservoir 66 by pressure sensors or switches (not shown) that are well known in the art.

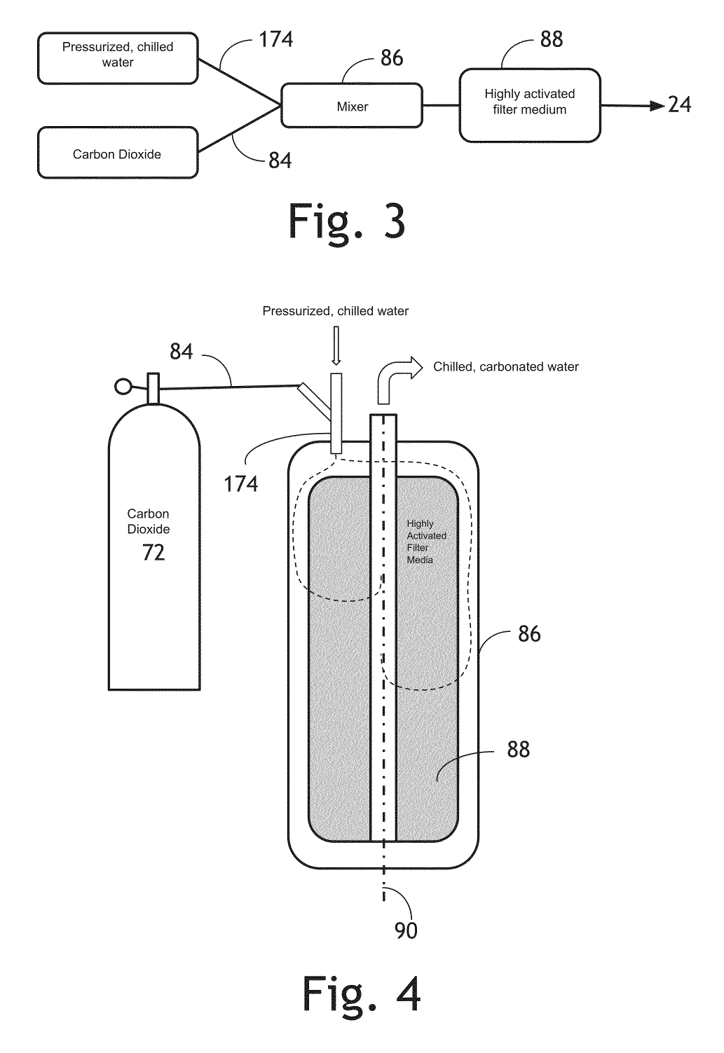

The carbonation process may be in an in-line, on-demand process as shown in the schematics in FIG. 3 and FIG. 4. A mixer 86 may be connected to a water source through a water line 174 and may be connected to a carbon dioxide source through a carbon dioxide line 84. There may be a filter media 88, which may be highly activated carbon filter media typically having a surface area of about 700 m²/gram, fluidly coupled to and disposed between the mixer 86 and the dispenser 24. The filter media 88 may be a highly activated carbon filter media with an even greater surface area, such as Hollow Carbon™ from Selecto, Inc, which has a surface area of about 1500 m²/gram. The surface area of the filter media may have a surface area of from at least about 700 m²/gram to about 1500 m²/gram or greater.

When the dispenser 24 is open, pressurized, preferably chilled water may enter a premixer 92 at a pressure of from about 60 to about 100 psi and a temperature of from about 3 to about 46° F. Carbon dioxide preferably may enter the mixer at 86 at a pressure of from about 60 to about 100 psi, typically 1-2 psig lower than the water pressure, allowing for some initial absorption of the carbon dioxide into the water. The flow then enters the mixer 86. The pressurized water and carbon dioxide mixture may then be forced through the filter media 88. The filter media 88 is designed to increase the surface area that the water and carbon dioxide mixture contacts, providing many more points of contact for the water and carbon dioxide to intermix and increasing the amount of absorption of the carbon dioxide into the water. The pressure from the water line 174 and the carbon dioxide line 84 continue to urge the carbonated water from the filter media 88 and out the dispenser 24 for use. It should be noted that depending on the filter media 88, different pressures and temperatures may be utilized. It may be desirable to choose a filter media 88 that is operable in higher pressure directly connected to a household water line, or a lower pressure to reduce pump size in a system that requires a pump to reach adequate pressure for the carbonization process. The increase in surface area provided by use of the filter media 88 allows for optimal carbonization at lower pressures than typical batch carbonation and thus allows for a reduction in pump lift or output to input pressure ratio. In another embodiment, the filter media 88 may be located within the mixer 86, wherein the filter media and the mixer share a common central axis 90.

In other embodiments, the carbonator may be a stand-alone device apart from a refrigerated appliance. A user may fill a reservoir with water and with ice if the user prefers chilled water. The water may then flow from the reservoir into a mixer where the above recited process follows. The carbonator may be a modular unit that may be taken out of the refrigerated appliance as a unit and taken to a different location. A previously-filled amount of chilled water and the above recited apparatus may be included in the module.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. An appliance for dispensing a carbonated liquid comprising:
a water source;
a carbon dioxide source;
a mixing chamber disposed downstream from the water source in fluid communication with the water source and the carbon dioxide source;
a filtration element disposed downstream from the mixing chamber in fluid communication with the mixing chamber; and
a dispenser in fluid communication with the filtration element.

2. The appliance of claim 1, wherein the filtration element is an activated carbon filter medium.

3. The appliance of claim 2, wherein the filtration element is disposed within the mixing chamber.

4. The appliance of claim 3, wherein the mixing chamber and the filtration element are disposed annularly about a shared central axis.

5. The appliance of claim 1, further comprising a cooling system to chill an amount of water from the water source.

6. The appliance of claim 5, wherein the cooling system comprises an evaporator in thermal contact with the amount of water.

7. The appliance of claim 1, wherein the filtration element is a porous metal.

8. The appliance of claim 1, wherein the water source is a household pumping water source or a manually filled reservoir.

9. The appliance of claim 2, wherein the activated carbon filter medium has a surface area of from about 700 m²/gram to about 1500 m^{2/}/gram.

10. A carbonated liquid dispenser comprising:
a water dispensing system comprising:
a water source;
a dispenser including a valve for selectively dispensing water;
a water line for the delivery of water from the water source to the dispenser; and
a cooling system in thermal contact with an amount of water between the water source and the dispenser; and
a carbonation system in fluid communication with and disposed between the water source and the dispenser comprising:
a carbon dioxide source;
a mixer in fluid communication with the water source and the carbon dioxide source and including a liquid outlet; and
a carbon filter medium in fluid communication with and disposed between the mixer and the dispenser.

11. The carbonation system of claim 10, wherein the carbon filter medium is an activated carbon filter medium.

12. The appliance of claim 11, wherein the activated carbon filter medium is disposed within the mixing chamber and the activated carbon filter medium has a surface area of at least about 700 m²/gram.

13. The appliance of claim 12, wherein the mixing chamber and the activated carbon filter medium are disposed annularly about a shared central axis.

14. The appliance of claim 12, wherein the activated carbon filter medium has a surface area of at least about 1500 m²/gram.

15. The appliance of claim 11, wherein the activated carbon filter medium has a surface area of from about 700 m²/gram to about 1500 m²/gram.

16. The appliance of claim 10, wherein the water source is a manually filled reservoir or a household plumbing water source.

17. A method of continuously adding carbonation to water comprising the steps of:
providing a water source;
cooling the water from the water source;
providing a carbon dioxide source;
mixing the water and an amount of carbon dioxide from the carbon dioxide source in a mixer which is fluidly coupled to the water source and the carbon dioxide source;
carbonating the water further by urging the water and the amount of carbon dioxide from the mixer through a highly activated carbon filter medium;
providing a dispenser including a user-controlled valve; and
dispensing the carbonated water from the carbon filter medium out of the dispenser.

18. The method of claim 17, wherein the step of providing a water source comprises fluidly coupling the mixer to a household water source.

19. The method of claim 17, wherein the step of providing a water source comprises manually filling a reservoir that is removably fluidly engaged with the mixer.

20. The method of claim 19, wherein the step of cooling the water from the water source manually adding ice to the reservoir.
